(19) United States
(12) Patent Application Publication
(10) Pub. No.: US 2017/0254211 A1
(43) Pub. Date: Sep. 7, 2017

(54) BLADED ROTOR ARRANGEMENT

(71) Applicant: ROLLS-ROYCE PLC, London (GB)

(72) Inventor: Mark R GIBSON, Berkshire (GB)

(73) Assignee: ROLLS-ROYCE PLC, London (GB)

(21) Appl. No.: 15/440,476

(22) Filed: Feb. 23, 2017

(30) Foreign Application Priority Data
Mar. 2, 2016 (GB) 1603603.0

(51) Int. Cl. F01D 5/30; F01D 5/32

(52) U.S. Cl. CPC F01D 5/3015; F01D 5/326; F05D 2220/32; F05D 2240/80; F05D 2260/30

(57) ABSTRACT

A gas turbine engine bladed rotor arrangement comprises a rotor, a plurality of rotor blades and a plurality of lock plates. The rotor blades are mounted in circumferentially spaced axially extending slots in the periphery of the rotor. A plurality of lock plates are arranged at a first axial end of the rotor. The radially outer ends of the lock plates engage corresponding grooves defined by radially inwardly extending flanges on the platforms of the rotor blades. The radially inner ends of the lock plates also engage a circumferentially extending groove. The radially outer end of at least one lock plate at the first axial end of the rotor has at least one projection extending axially away from the rotor. Each projection locates against a corresponding anti-rotation feature.

The present disclosure relates to a bladed rotor arrangement and in particular to a bladed rotor arrangement of a gas turbine engine or a turbomachine.

Gas turbine engines comprise a plurality of bladed rotors, each of which comprises a rotor and a plurality of rotor blades mounted on the periphery of the rotor. Each rotor blades has an aerofoil, a platform, a shank and a root. The rotor comprises a plurality of circumferentially spaced axially extending slots. The root of each rotor blade is arranged to locate in a respective one of the axially extending slots in the periphery of the rotor. The roots of the rotor blades are generally fir tree shaped, or dovetail shaped, and the axially extending slots are correspondingly shaped to receive the roots of the rotor blades.

The bladed rotor arrangement also comprises a plurality of lock plates arranged at a first axial end of the rotor and a plurality of lock plates arranged at a second axial end of the rotor to prevent the rotor blades moving axially relative to the rotor. The lock plates also acts as seals to prevent fluid flowing through the axially extending slots in the rotor and axially between the shanks of the rotor blades and radially between the platforms of the rotor blades and the periphery of the rotor. The radially outer ends of lock plates at the first axial end of the rotor engage grooves defined by radially inwardly extending flanges on the platforms of the rotor blades and the radially outer ends of the lock plates at the second axial end of the rotor engage grooves defined by radially inwardly extending flanges on the platforms of the rotor blades. The radially inner ends of the lock plates engage circumferentially extending grooves in the rotor or circumferentially extending grooves defined by seal plates and the rotor.

One type of lock plate comprises two circumferentially spaced axially extending projections which are arranged to prevent the lock plates rotating around the rotor during operation of the gas turbine engine. The lock plates may be arranged such that the shank of each rotor blade is positioned circumferentially between the circumferentially spaced projections of a corresponding one of the lock plates.

Alternatively the lock plates may be arranged such that the projections of each lock plate are positioned circumferentially between the shanks of two circumferentially adjacent rotor blades. The lock plates are initially bent to enable assembly and are then flattened such that the radially inner ends and the radially outer ends of the lock plates locate in the circumferentially extending grooves.

However, the arrangements described suffer from a number of problems. A first problem is that in operation the engagement between the projections on the lock plates and the shanks of the rotor blades is at a minimum due to the lock plates moving radially outwardly and axially away from the rotor. A second problem is that during assembly it is difficult to ensure that the projections on a lock plate do not contact the shank of a rotor blade during the flattening of the lock plate. A third problem is that the projections on the lock plates engage the shanks of the rotor blades to prevent rotation of the lock plates, but the shanks of the rotor blades are highly stressed and engagement with the shanks of the rotor blades increases the stress in the shanks of the rotor blades.

Therefore the present disclosure seeks to provide a novel bladed rotor arrangement which reduces or overcomes the above mentioned problem.

Accordingly the present disclosure provides a bladed rotor arrangement comprising a rotor, a plurality of rotor blades and a plurality of lock plates,
the rotor blades being mounted on the periphery of the rotor, each rotor blade comprising an aerofoil, a platform, a shank and a root, the platform of each rotor blade having a first axial end, the first axial end of the platform of each rotor blade having a radially inwardly extending flange which defines a groove,
the rotor having a first axial end and a second axial end, the rotor comprising a plurality of circumferentially spaced axially extending slots, the root of each rotor blade locating in a respective one of the axially extending slots in the periphery of the rotor,
each lock plate having a radially inner end and a radially outer end,
a first plurality of lock plates being arranged at the first axial end of the rotor, the radially outer ends of the lock plates at the first axial end of the rotor engaging the grooves defined by the radially inwardly extending flanges at the first axial ends of the platforms of the rotor blades, the radially inner ends of the lock plates at the first axial end of the rotor engaging a circumferentially extending groove,
wherein the radially inner end or the radially outer end of at least one lock plate at the first axial end of the rotor having at least one projection extending axially away from the rotor, the at least one projection locating against a corresponding anti-rotation feature.

The platform of each rotor blade may have a second axial end, the second axial end of the platform of each rotor blade having a radially inwardly extending flange which defines a groove, a second plurality of lock plates being arranged at the second axial end of the rotor, the radially outer ends of the lock plates at the second axial end of the rotor engaging the grooves defined by the radially inwardly extending flanges at the second axial ends of the platforms of the rotor blades, the radially inner ends of the lock plates at the second axial end of the rotor engaging a circumferentially extending groove,
wherein the radially inner end or the radially outer end of at least one lock plate at the second axial end of the rotor having at least one projection extending axially away from the rotor, the at least one projection locating against a corresponding anti-rotation feature.

The radially inner end or the radially outer end of each lock plate at the first axial end of the rotor may have at least one projection extending axially away from the rotor, the at least one projection of each lock plate locating against a corresponding anti-rotation feature.

The radially inner end or the radially outer end of each lock plate at the second axial end of the rotor may have at least one projection extending axially away from the rotor, the at least one projection of each lock plate locating against a corresponding anti-rotation feature.

The radially outer end of each lock plate at the first axial end of the rotor may have at least one projection extending axially away from the rotor, the at least one projection of each lock plate locating in a corresponding axially extending slot in the radially inwardly extending flange of a corresponding one of the rotor blades.

The radially outer end of each lock plate at the first axial end of the rotor may have at least one projection extending axially away from the rotor, the at least one projection of each lock plate locating in a corresponding axially extending slot defined between the radially inwardly extending flanges of two circumferentially adjacent rotor blades.

The radially outer end of each lock plate at the first axial end of the rotor may have at least two circumferentially spaced projections extending axially away from the rotor to define a radially extending slot, the radially inwardly extending flange of each rotor blade having at least one radially inwardly extending projection, the at least one radially inwardly extending projection of each rotor blade locating in a radially extending slot defined between the axially extending projections on a corresponding one of the lock plates.

The axially extending projections of each lock plate may abut a radially inner surface of the radially inwardly extending flange of the corresponding rotor blade.

The rotor may have a circumferentially extending hook, the hook comprising a first portion extending axially away from the rotor and a second portion extending radially outwardly, the circumferentially extending groove being defined by the rotor and the hook, the second portion of the hook having a plurality of circumferentially spaced radially extending grooves, the radially inner end of each lock plate at the first axial end of the rotor may have at least one projection extending axially away from the rotor, the at least one projection of each lock plate locating in a corresponding one of the radially extending grooves.

The bladed rotor arrangement may comprise at least one seal plate arranged at the first axial end of the rotor, the radially inner ends of the lock plates at the first axial end of the rotor engaging a circumferentially extending groove at least partially defined by the at least one seal plate at the first axial end of the rotor.

The bladed rotor arrangement may comprise a plurality of seal plates arranged at the first axial end of the rotor.

The bladed rotor arrangement may comprise a plurality of seal plates arranged at the second axial end of the rotor.

The roots of the rotor blades may be generally fir tree shaped, or dovetail shaped, and the axially extending slots are correspondingly shaped to receive the roots of the rotor blades.

The radially outer end of each lock plate may have a lip and the radially inner end of each lock plate may have a lip.

Each lock plate may have a first face facing away from the rotor and a second face facing the rotor.

The first face of each lock plate may be generally flat between the lips at the radially inner and radially outer ends of the lock plate.

The bladed rotor arrangement may comprise a turbine disc and a plurality of turbine rotor blades.

The present disclosure will be more fully described by way of example with reference to the accompanying drawings, in which:

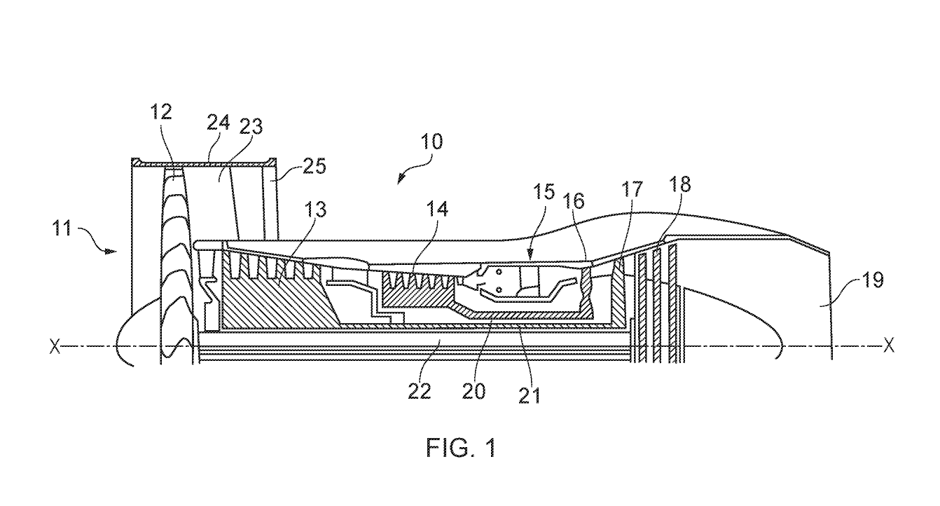

FIG. 1 is sectional side view of an upper half of a turbofan gas turbine engine having a bladed rotor arrangement according to the present disclosure.

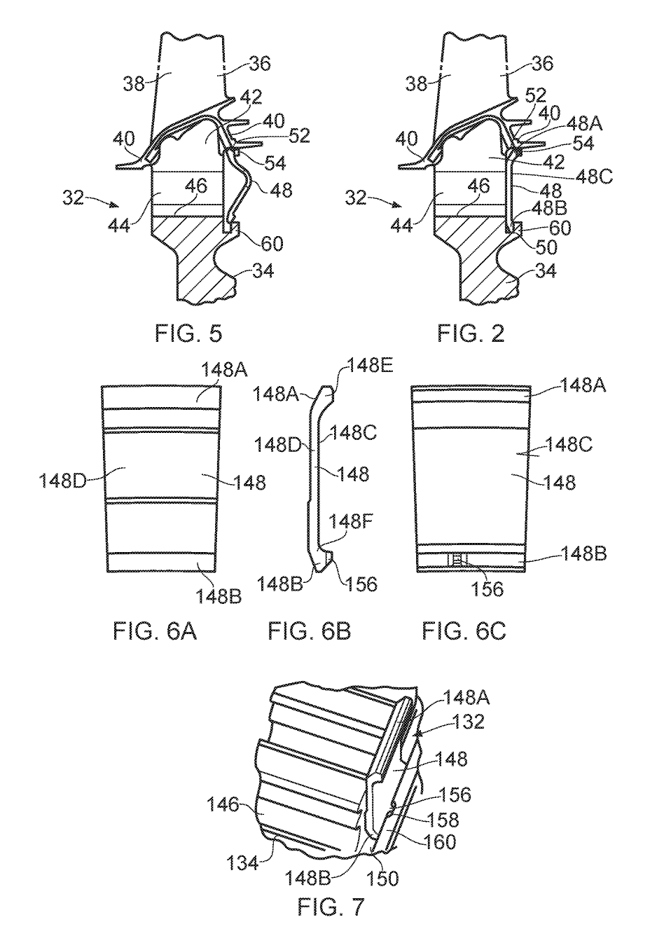

FIG. 2 is a cross-sectional view of part of a turbine of the turbofan gas turbine engine showing the bladed rotor arrangement according to the present disclosure.

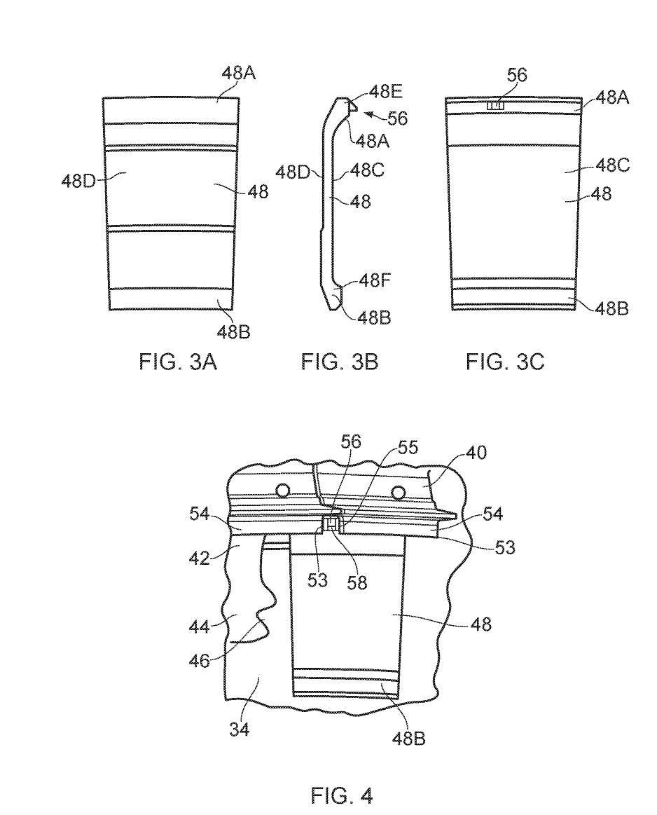

FIGS. 3A, 3B and 3C are enlarged views of a lock plate for the bladed rotor arrangement according to the present disclosure.

FIG. 4 is a perspective view of part of the bladed rotor arrangement according to the present disclosure.

FIG. 5 is a cross-sectional view of part of a turbine of the turbofan gas turbine engine showing assembly of a lock plate into the bladed rotor arrangement according to the present disclosure.

FIGS. 6A, 6B and 6C are enlarged views of another lock plate for the bladed rotor arrangement according to the present disclosure.

FIG. 7 is a perspective view of a part of another bladed rotor arrangement according to the present disclosure.

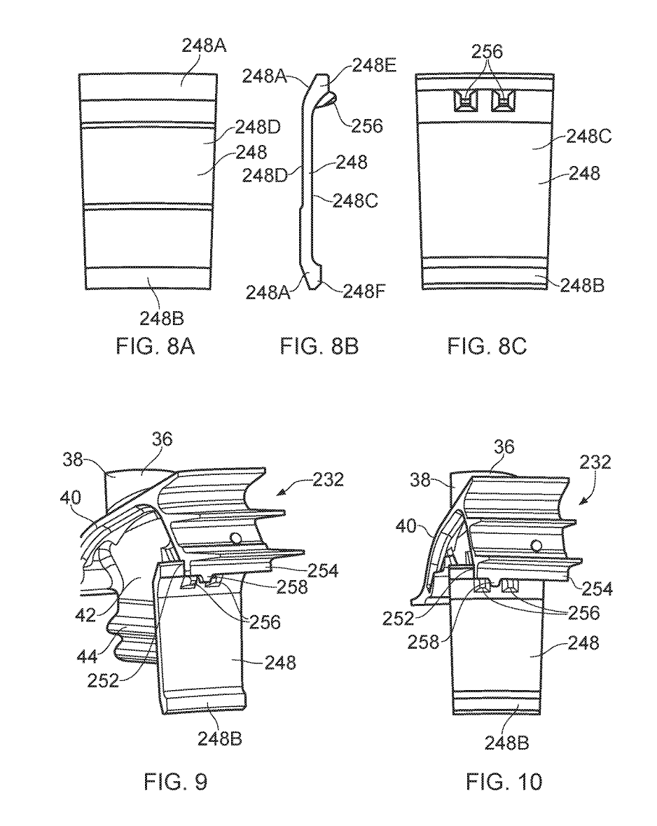

FIG. 8A, 8B and 8C are enlarged views of a further lock plate for the bladed rotor arrangement according to the present disclosure.

FIG. 9 is a perspective view of part of a further bladed rotor arrangement according to the present disclosure.

FIG. 10 is another perspective view of part of the further bladed rotor arrangement according to the present disclosure.

A turbofan gas turbine engine 10, as shown in FIG. 1, comprises in flow series an intake 11, a fan 12, an intermediate pressure compressor 13, a high pressure compressor 14, a combustion chamber 15, a high pressure turbine 16, an intermediate pressure turbine 17, a low pressure turbine 18 and an exhaust 19. The high pressure turbine 16 is arranged to drive the high pressure compressor 14 via a first shaft 20. The intermediate pressure turbine 17 is arranged to drive the intermediate pressure compressor 13 via a second shaft 21 and the low pressure turbine 18 is arranged to drive the fan 12 via a third shaft 22. In operation air flows into the intake 11 and is compressed by the fan 12. A first portion of the air flows through, and is compressed by, the intermediate pressure compressor 13 and the high pressure compressor 14 and is supplied to the combustion chamber 15. Fuel is injected into the combustion chamber 15 and is burnt in the air to produce hot exhaust gases which flow through, and drive, the high pressure turbine 16, the intermediate pressure turbine 17 and the low pressure turbine 18. The hot exhaust gases leaving the low pressure turbine 18 flow through the exhaust 19 to provide propulsive thrust. A second portion of the air bypasses the main engine and flows through a bypass duct 23 defined by a fan casing 24. The second portion of air leaving the bypass duct 23 flows through a bypass, or fan, nozzle 25 to provide propulsive thrust.

A part of the intermediate pressure turbine 17 of the turbofan gas turbine engine 10 is shown more clearly in FIGS. 2 to 5. The intermediate pressure turbine 17 comprises a bladed turbine rotor arrangement 32. The bladed turbine rotor arrangement 32 comprises a turbine rotor 34, a plurality of turbine rotor blades 36 and a plurality of lock plates 48. The turbine rotor blades 36 are mounted on the periphery of the turbine rotor 34 and each turbine rotor blade 36 comprises an aerofoil 38, a platform 40, a shank 42 and a root 44. The turbine rotor 34 comprises a plurality of circumferentially spaced axially extending slots 46 and the root 44 of each turbine rotor blade 36 locates in a respective one of the axially extending slots 46 in the periphery of the turbine rotor 34. The turbine rotor 34 in this example comprises a turbine disc. The roots 44 of the turbine rotor blades 36 are generally fir tree shaped and the axially extending slots 46 are correspondingly shaped to receive the roots 44 of the turbine rotor blades 36. However, the roots 44 of the turbine rotor blades 36 may be dovetail shaped and the axially extending slots 46 are correspondingly shaped to receive the roots 44 of the turbine rotor blades 36.

A plurality of lock plates 48 are arranged at a first axial end, the downstream end, of the turbine rotor 34. The lock plates 48 prevent the turbine rotor blades 36 moving axially upstream and downstream respectively relative to the turbine rotor 34. The lock plates 48 also acts as seals to prevent fluid flowing through the axially extending slots 46 in the turbine rotor 34 and axially between the shanks 42 of the turbine rotor blades 36 and radially between the platforms 40 of the turbine rotor blades 36 and the periphery of the turbine rotor 34. The radially outer ends 48A of the lock plates 48 at the first axial end of the turbine rotor 34 engage grooves 52 defined by radially inwardly extending flanges 54 on the first axial ends, downstream ends, of the platforms 40 of the turbine rotor blades 36. The radially inner ends 48B of the lock plates 48 engage a circumferentially extending groove 50. The turbine rotor 34 has a circumferentially extending hook 60 and the hook 60 comprises a first portion extending axially away from the turbine rotor 34 and a second portion extending radially outwardly. The circumferentially extending groove 50 is defined by the axially downstream face of the turbine rotor 34 and the hook 60, as shown in FIG. 2.

The radially outer end 48A of each lock plate 48 has a lip 48E and the radially inner end 48B of each lock plate 48 has a lip 48F. Each lock plate 48 has a first face 48C facing away from the turbine rotor 34 and a second face 48D facing the turbine rotor 34. The first face 48C of each lock plate 48 is generally flat between the lips at the radially inner and radially outer ends 48A and 48B of the lock plate 48. The second face 48D of each lock plate 48 is generally flat between the lips at the radially inner and radially outer ends 48A and 48B of the lock plate 48, as seen in FIGS. 3A to 3C.

The radially outer end 48A of each lock plate 48 has a projection 56 extending from the lip 48E and axially away from the turbine rotor 34, the projection 56 of each lock plate 48 locates in a corresponding axially extending slot 58 defined between the radially inwardly extending flanges 54 of two circumferentially adjacent turbine rotor blades 36. In this arrangement each lock plate 48 overlaps the radially inwardly extending flanges 54 of two circumferentially adjacent turbine rotor blades 36. The radially inwardly extending flange 54 of each turbine rotor blade 36 does not extend the full circumferential distance of the platform 40. The radially inwardly extending flange 54 of each turbine rotor blade 36 has a first end 53 at a first circumferential end of the platform 40 and a second end 55 spaced from a second circumferential end of the platform 40. Each axially extending slot 58 is defined between the second end 55 of the flange 54 and the platform 40 of one turbine rotor blade 36 and the first end 53 of the flange 54 of a circumferentially adjacent turbine rotor blade 36, as seen in FIGS. 3A to 3C and FIG. 4.

In an alternative arrangement the radially outer end 48A of each lock plate 48 has a projection 56 extending from the lip 48E and axially away from the turbine rotor 34, the projection 56 of each lock plate 48 locates in a corresponding axially extending slot 58 in the radially inwardly extending flange 54 of a corresponding one of the turbine rotor blades 36. Thus, the radially inwardly extending flange 54 has a first portion extending a first predetermined distance from the first circumferential end of the platform 40 and a second portion extending a second predetermined distance from the second circumferential end of the platform 40 to leave a slot 58 between the first and second portions of the radially inwardly extending flange 54.

In operation, the axially extending projection 56 on each lock plate 48 is located in a corresponding axially extend slot 58 and thus each lock plate 48 is prevented from rotating around the turbine rotor 32 during operation of the gas turbine engine 10.

FIG. 5 is similar to FIG. 3 but shows the lock plates 48 being assembled into the bladed turbine rotor arrangement 32 before flattening of the lock plates 48.

The advantage of the present disclosure is that the engagement between the axially extending projections 56 on the lock plates 48 and the slots 58 in the radially extending flanges 54 of the turbine rotor blades 36 is at a maximum when the gas turbine engine 10 is operating due to the lock plates 48 moving radially outwardly and axially away from the turbine rotor 34 and hence the axially extending projections 56 are forced into greater engagement with the slots 58. During assembly the projection 56 on the lock plate 48 does not contact the shank 42 of a turbine rotor blade 36 during the flattening of the lock plate 48 because the axially extending projection 56 extends away from the turbine rotor 34 and turbine rotor blades 36. The axially extending projections 56 on the lock plates 48 do not engage the shanks 42 of the turbine rotor blades 36 to prevent rotation of the lock plates 48 and hence the stress in the shanks 42 of the turbine rotor blades 36 is not increased by the lock plates 48. Additionally, the axially extending projections 56 and the axially extending slots 58 provide a visual indication that the lock plates 48 are correctly positioned in relation to the turbine rotor blades 36. The resilience, spring-back, of the flattened lock plates 48 returning the lock plates 48 to their pre-assembled bent shape maximises the engagement of the axially extending projections 56 with the axially extending slots 58.

An alternative bladed turbine rotor arrangement 132 is shown more clearly in FIGS. 6A to 6C and 7. The bladed turbine rotor arrangement 132 is substantially the same as the bladed turbine rotor arrangement 32. A plurality of lock plates 148 are arranged at a first axial end, the downstream end, of a turbine rotor 134. The lock plates 148 prevent the turbine rotor blades moving axially upstream and downstream respectively relative to the turbine rotor 134. The lock plates 148 also acts as seals to prevent fluid flowing through the axially extending slots 146 in the turbine rotor 134 and axially between the shanks of the turbine rotor blades and radially between the platforms of the turbine rotor blades and the periphery of the turbine rotor 134. The radially outer ends 148A of the lock plates 148 at the first axial end of the turbine rotor 134 engage grooves defined by radially inwardly extending flanges on the first axial ends, downstream ends, of the platforms of the turbine rotor blades. The radially inner ends 148B of the lock plates 148 engage a circumferentially extending groove 150. The turbine rotor 134 has a circumferentially extending hook 160 and the hook 160 comprises a first portion extending axially away from the turbine rotor 134 and a second portion extending radially outwardly. The circumferentially extending groove 150 is defined by the turbine rotor 134 and the hook 160. The second portion of the hook 160 has a plurality of circumferentially spaced radially and axially extending grooves 158 provided in a face of the second portion of the hook 160 facing the first axial end, the downstream end, of the turbine rotor 134, but only one lock plate 148 and one slot 158 is shown in FIG. 7.

The radially outer end 148A of each lock plate 148 has a lip 148E and the radially inner end 148B of each lock plate 148 has a lip 148F. Each lock plate 148 has a first face 148C facing away from the turbine rotor 134 and a second face 148D facing the turbine rotor 134. The first face 148C of each lock plate 148 is generally flat between the lips at the radially inner and radially outer ends 148A and 148B of the lock plate 148. The second face 148D of each lock plate 148 is generally flat between the lips at the radially inner and radially outer ends 148A and 148B of the lock plate 148, as seen in FIGS. 6A to 6C.

The radially inner end 148B of each lock plate 148 has a projection 156 extending from the lip 148F and axially away from the turbine rotor 134. The projection 156 of each lock plate 148 locates in a corresponding one of the radially and axially extending grooves 158. In this arrangement each lock plate 148 overlaps the radially inwardly extending flanges of two circumferentially adjacent turbine rotor blades. The radially inwardly extending flange of each turbine rotor blade extends the full circumferential distance of the platform.

Alternatively, it may be possible to provide a plurality, e.g. two, axially extending projections 156 on each lock plate 148 and a corresponding number of radially and axially extending grooves 158 in the hook 160 of the turbine rotor 134.

This arrangement of the present disclosure has the same advantages as the previous arrangement. The further advantage of this arrangement of the present disclosure relative to the previous arrangement is that the axially extending projections 156 on the lock plates 148 do not engage the turbine rotor blades 36 to prevent rotation of the lock plates 148 and only the radially outer ends 148A of the lock plates 148 contact the turbine rotor blades. Additionally, the lock plates 148 have less weight because the axially extending projections 156 do not need to be as large, e.g. axially as long and/or radially as deep and the weight of the turbine rotor 134 is reduced slightly.

An alternative bladed turbine rotor arrangement 232 is shown more clearly in FIGS. 8A to 8C, 9 and 10. The bladed turbine rotor arrangement 232 is substantially the same as the bladed turbine rotor arrangement 32. A plurality of lock plates 248 are arranged at a first axial end, the downstream end, of a turbine rotor. The lock plates 248 prevent the turbine rotor blades 36 moving axially upstream and downstream respectively relative to the turbine rotor. The lock plates 248 also acts as seals to prevent fluid flowing through the axially extending slots in the turbine rotor and axially between the shanks 42 of the turbine rotor blades 36 and radially between the platforms 40 of the turbine rotor blades 36 and the periphery of the turbine rotor. The radially outer ends 248A of the lock plates 248 at the first axial end of the turbine rotor engage grooves 252 defined by radially inwardly extending flanges 254 on the first axial ends, downstream ends, of the platforms 40 of the turbine rotor blades 36. The radially inner ends 248B of the lock plates 248 engage a circumferentially extending groove. The turbine rotor has a circumferentially extending hook and the hook comprises a first portion extending axially away from the turbine rotor and a second portion extending radially outwardly. The circumferentially extending groove is defined by the turbine rotor and the hook.

The radially outer end 248A of each lock plate 248 has a lip 248E and the radially inner end 248B of each lock plate 248 has a lip 248F. Each lock plate 248 has a first face 248C facing away from the turbine rotor and a second face 248D facing the turbine rotor. The first face 248C of each lock plate 248 is generally flat between the lips at the radially inner and radially outer ends 248A and 248B of the lock plate 248. The second face 248D of each lock plate 248 is generally flat between the lips at the radially inner and radially outer ends 248A and 248B of the lock plate 248, as seen in FIGS. 8A to 8C.

The radially outer end 248A of each lock plate 248 has two circumferentially spaced projections 256 extending from the lock plate 248 and axially away from the turbine rotor to define a radially extending slot. The radially inwardly extending flange 254 of each rotor blade 36 has a radially inwardly extending projection 258 and the radially inwardly extending projection 258 of each rotor blade 36 locates in a radially extending slot defined between the two axially extending projections 256 on a corresponding one of the lock plates 248. In this arrangement each lock plate 248 overlaps the radially inwardly extending flanges 254 of two circumferentially adjacent turbine rotor blades 36. The radially inwardly extending flange 254 of each turbine rotor blade 36 extends the full circumferential distance of the platform 40, as shown in FIGS. 9 and 10.

Alternatively, it may be possible to provide more than two, e.g. three, axially extending projections 256 on each lock plate 248 to provide two, or more, radially extending slots and a corresponding number of, e.g. two, radially inwardly extending projections 258 on the flange 254 of each turbine rotor blade 36.

This arrangement of the present disclosure has the same advantages as the first arrangement.

In all of the arrangements described the, or each, axially extending projection on the radially outer end, or the radially inner end, of each lock plate is integral with the lock plate, e.g. the, or each, axially extending projection on the radially outer end, or the radially inner end, of each lock plate and the lock plate are a single, unitary, monolithic piece.

Although the present disclosure has been described with reference to the lock plates being arranged at the downstream end of the turbine rotor it may be equally possible to provide the lock plates at the upstream end of the turbine rotor. Additionally, it may be possible to provide lock plates at a first, downstream, end of the turbine rotor and to provide lock plates at a second, upstream, end of the turbine rotor.

Although the present disclosure has been described with reference to the radially inner ends of the lock plates locating in a circumferentially extending groove defined by the turbine rotor and a hook having a first portion extending axially and a second portion extending radially outwardly, it is equally possible for the circumferentially extending groove to be defined by the turbine rotor and one or more seal plates.

Although the present disclosure has been described with reference to a bladed turbine rotor arrangement of an intermediate pressure turbine it is equally applicable to a bladed turbine rotor arrangement of a high pressure turbine or a low pressure turbine.

Although the present disclosure has been described with reference to a bladed turbine rotor arrangement it is equally applicable to a bladed compressor rotor arrangement, whether a high pressure compressor, an intermediate pressure compressor or a low pressure compressor or a fan. A bladed compressor rotor may comprise a compressor disc or a compressor drum. The bladed compressor rotor arrangement may comprise a compressor disc and a plurality of compressor rotor blades or a compressor drum and a plurality of compressor rotor blades.

Although the present disclosure has been described with reference to bladed rotor arrangement for a gas turbine engine, it is equally applicable to a bladed rotor arrangement for other types of turbomachine, e.g. a steam turbine etc.

1. A bladed rotor arrangement comprising a rotor, a plurality of rotor blades and a plurality of lock plates,
the rotor blades being mounted on the periphery of the rotor, each rotor blade comprising an aerofoil, a platform, a shank and a root, the platform of each rotor blade having a first axial end, the first axial end of the platform of each rotor blade having a radially inwardly extending flange which defines a groove,
the rotor having a first axial end and a second axial end, the rotor comprising a plurality of circumferentially spaced axially extending slots, the root of each rotor blade locating in a respective one of the axially extending slots in the periphery of the rotor,
each lock plate having a radially inner end and a radially outer end,
a first plurality of lock plates being arranged at the first axial end of the rotor, the radially outer ends of the lock plates at the first axial end of the rotor engaging the grooves defined by the radially inwardly extending flanges at the first axial ends of the platforms of the rotor blades, the radially inner ends of the lock plates at the first axial end of the rotor engaging a circumferentially extending groove,
wherein one of the radially inner end and the radially outer end of at least one lock plate at the first axial end of the rotor having at least one projection extending axially away from the rotor, the at least one projection locating against a corresponding anti-rotation feature.

2. A bladed rotor arrangement as claimed in claim 1 wherein one of the radially inner end and the radially outer end of each lock plate at the first axial end of the rotor having at least one projection extending axially away from the rotor, the at least one projection of each lock plate locating against a corresponding anti-rotation feature.

3. A bladed rotor arrangement as claimed in claim 1 wherein the platform of each rotor blade having a second axial end, the second axial end of the platform of each rotor blade having a radially inwardly extending flange which defines a groove,
a second plurality of lock plates being arranged at the second axial end of the rotor, the radially outer ends of the lock plates at the second axial end of the rotor engaging the grooves defined by the radially inwardly extending flanges at the second axial ends of the platforms of the rotor blades, the radially inner ends of the lock plates at the second axial end of the rotor engaging a circumferentially extending groove,
wherein one of the radially inner end and the radially outer end of at least one lock plate at the second axial end of the rotor having at least one projection extending axially away from the rotor, the at least one projection locating against a corresponding anti-rotation feature.

4. A bladed rotor arrangement as claimed in claim 3 wherein one of the radially inner end and the radially outer end of each lock plate at the second axial end of the rotor having at least one projection extending axially away from the rotor, the at least one projection of each lock plate locating against a corresponding anti-rotation feature.

5. A bladed rotor arrangement as claimed in claim 2 wherein the radially outer end of each lock plate at the first axial end of the rotor having at least one projection extending axially away from the rotor, the at least one projection of each lock plate locating in a corresponding axially extending slot in the radially inwardly extending flange of a corresponding one of the rotor blades.

6. A bladed rotor arrangement as claimed in claim 2 wherein the radially outer end of each lock plate at the first axial end of the rotor having at least one projection extending axially away from the rotor, the at least one projection of each lock plate locating in a corresponding axially extending slot defined between the radially inwardly extending flanges of two circumferentially adjacent rotor blades.

7. A bladed rotor arrangement as claimed in claim 2 wherein the radially outer end of each lock plate at the first axial end of the rotor having at least two circumferentially spaced projections extending axially away from the rotor to define a radially extending slot, the radially inwardly extending flange of each rotor blade having at least one radially inwardly extending projection, the at least one radially inwardly extending projection of each rotor blade locating in a radially extending slot defined between the axially extending projections on a corresponding one of the lock plates.

8. A bladed rotor arrangement as claimed in claim 7 the axially extending projections of each lock plate abutting a radially inner surface of the radially inwardly extending flange of the corresponding rotor blade.

9. A bladed rotor arrangement as claimed in claim 2 wherein the rotor having a circumferentially extending hook, the hook comprising a first portion extending axially away from the rotor and a second portion extending radially outwardly, the circumferentially extending groove being defined by the rotor and the hook, the second portion of the hook having a plurality of circumferentially spaced radially extending grooves, the radially inner end of each lock plate at the first axial end of the rotor having at least one projection extending axially away from the rotor, the at least one projection of each lock plate locating in a corresponding one of the radially extending grooves.

10. A bladed rotor arrangement as claimed in claim 1 wherein the bladed rotor arrangement comprising at least one seal plate arranged at the first axial end of the rotor, the radially inner ends of the lock plates at the first axial end of the rotor engaging a circumferentially extending groove at least partially defined by the at least one seal plate at the first axial end of the rotor.

11. A bladed rotor arrangement as claimed in claim 1 wherein the roots of the rotor blades being generally fir tree shaped or dovetail shaped and the axially extending slots are correspondingly shaped to receive the roots of the rotor blades.

12. A bladed rotor arrangement as claimed in claim 1 wherein the radially outer end of each lock plate having a lip and the radially inner end of each lock plate having a lip.

13. A bladed rotor arrangement as claimed in claim 1 wherein each lock plate having a first face facing away from the rotor and a second face facing the rotor.

14. A bladed rotor arrangement as claimed in claim 1 wherein the first face of each lock plate being generally flat between the lips at the radially inner and radially outer ends of the lock plate.

15. A bladed rotor arrangement as claimed in claim 1 wherein the bladed rotor arrangement comprising a turbine disc and a plurality of turbine rotor blades.

16. A bladed rotor arrangement as claimed in claim 1 wherein the rotor having a circumferentially extending hook, the hook comprising a first portion extending axially away from the rotor and a second portion extending radially outwardly, the circumferentially extending groove being defined by the rotor and the hook.

17. A bladed rotor arrangement as claimed in claim 2 wherein each axially extending projection on the radially outer end, or the radially inner end, of the lock plate and the lock plate being a monolithic piece.

18. A bladed rotor arrangement comprising a rotor, a plurality of rotor blades and a plurality of lock plates,
rotor blades being mounted on the periphery of the rotor, each rotor blade comprising an aerofoil, a platform, a shank and a root, the platform of each rotor blade having a first axial end, the first axial end of the platform of each rotor blade having a radially inwardly extending flange which defines a groove,
the rotor having a first axial end and a second axial end, the rotor comprising a plurality of circumferentially spaced axially extending slots, the root of each rotor blade locating in a respective one of the axially extending slots in the periphery of the rotor,
each lock plate having a radially inner end and a radially outer end,
a first plurality of lock plates being arranged at the first axial end of the rotor, the radially outer ends of the lock plates at the first axial end of the rotor engaging the grooves defined by the radially inwardly extending flanges at the first axial ends of the platforms of the rotor blades, the radially inner ends of the lock plates at the first axial end of the rotor engaging a circumferentially extending groove,
wherein the radially outer end of each lock plate at the first axial end of the rotor having at least one projection extending axially away from the rotor, the at least one projection of each lock plate locating in a corresponding axially extending slot defined between the radially inwardly extending flanges of two circumferentially adjacent rotor blades.

19. A bladed rotor arrangement comprising a rotor, a plurality of rotor blades and a plurality of lock plates,
the rotor blades being mounted on the periphery of the rotor, each rotor blade comprising an aerofoil, a platform, a shank and a root, the platform of each rotor blade having a first axial end, the first axial end of the platform of each rotor blade having a radially inwardly extending flange which defines a groove,
the rotor having a first axial end and a second axial end, the rotor comprising a plurality of circumferentially spaced axially extending slots, the root of each rotor blade locating in a respective one of the axially extending slots in the periphery of the rotor,
each lock plate having a radially inner end and a radially outer end,
a first plurality of lock plates being arranged at the first axial end of the rotor, the radially outer ends of the lock plates at the first axial end of the rotor engaging the grooves defined by the radially inwardly extending flanges at the first axial ends of the platforms of the rotor blades, the radially inner ends of the lock plates at the first axial end of the rotor engaging a circumferentially extending groove,
wherein the radially outer end of each lock plate at the first axial end of the rotor having at least two circumferentially spaced projections extending axially away from the rotor to define a radially extending slot, the radially inwardly extending flange at the first axial end of the platform of each rotor blade having at least one radially inwardly extending projection, the at least one radially inwardly extending projection of each rotor blade locating in a radially extending slot defined between the axially extending projections on a corresponding one of the lock plates.

20. A bladed rotor arrangement comprising a rotor, a plurality of rotor blades and a plurality of lock plates,
the rotor blades being mounted on the periphery of the rotor, each rotor blade comprising an aerofoil, a platform, a shank and a root, the platform of each rotor blade having a first axial end, the first axial end of the platform of each rotor blade having a radially inwardly extending flange which defines a groove,
the rotor having a first axial end and a second axial end, the rotor comprising a plurality of circumferentially spaced axially extending slots, the root of each rotor blade locating in a respective one of the axially extending slots in the periphery of the rotor,
the rotor having a circumferentially extending hook, the hook comprising a first portion extending axially away from the rotor and a second portion extending radially outwardly, a circumferentially extending groove being defined by the rotor and the hook,
each lock plate having a radially inner end and a radially outer end,
a first plurality of lock plates being arranged at the first axial end of the rotor, the radially outer ends of the lock plates at the first axial end of the rotor engaging the grooves defined by the radially inwardly extending flanges at the first axial ends of the platforms of the rotor blades, the radially inner ends of the lock plates at the first axial end of the rotor engaging the circumferentially extending groove,
wherein the second portion of the hook having a plurality of circumferentially spaced radially extending grooves, the radially inner end of each lock plate at the first axial end of the rotor having at least one projection extending axially away from the rotor, the at least one projection of each lock plate locating in a corresponding one of the radially extending grooves.
